(19) United States
(12) Patent Application Publication
(10) Pub. No.: US 2009/0266799 A1
(43) Pub. Date: Oct. 29, 2009

(54) Method for Operating a Steam Plasma Burner and Steam Cutting Device

(76) Inventors: Heribert Pauser, Grafenworth (AT); Alexander Speigner, Wels (AT); Andreas Starzengruber, Bad Wimsbach-Neydharting (AT); Max Stöger, Vorchdorf (AT)

Correspondence Address: COLLARD & ROE, P.C., 1077 NORTHERN BOULEVARD, ROSLYN, NY, 11576, US

(21) Appl. No.: 11/991,627

(22) PCT Filed: Sep. 6, 2006
(86) PCT No.: PCT/AT2006/000365

§ 371 Date: Mar. 18, 2008

(30) Foreign Application Priority Data
Sep. 9, 2005 (AT) A 1482/2005

(51) Int. Cl. H05H 1/34; B23K 10/00

(52) U.S. Cl. 219/121.44; 219/121.59; 219/121.54

(57) ABSTRACT

The invention relates to a method for operation of a steam plasma burner (6), comprising a cathode (22) and an anode (24) in the form of a nozzle (23) for machining a workpiece (20), wherein during the operation a current is applied between the cathode (22) and the anode (24) and/or the workpiece (20) by means of a power supply (2). After starting a pilot arc between the cathode (22) and the anode (24) by approaching the steam plasma burner (6) to the workpiece (20), a working arc is formed between the cathode (22) and the workpiece (20) and the pilot arc is extinguished by switching off the power supply (2) to the anode (24) and the current increased to a given working current. In order to achieve an optimal operation of a steam plasma burner, the voltage (U_{UE}) between the cathode (22) and the workpiece (20) is monitored during working operation and the power supply (2) reconnected to the anode (24) to reform the pilot arc when the voltage (U_{UE}) exceeds a threshold (I_{UEs}).

The invention relates to a method for operating a steam plasma burner including a cathode and an anode in the form of a nozzle for processing a workpiece, wherein during operation a current is impressed between the cathode and the anode and/or the workpiece by the aid of a power source, whereby, after the ignition of a pilot arc between the cathode and the anode, a working arc is formed between the cathode and the workpiece by the steam plasma burner approaching the workpiece, and the pilot arc is extinguished by the power source being switched off from the anode, and the current is increased to a predetermined operating current.

The invention further relates to a steam cutting device including a steam plasma burner including a cathode and an anode in the form of a nozzle, a power source connected with the cathode, on the one hand, and the workpiece to be processed as well as the anode, on the other hand, and a control device for controlling a switch arranged in the connection between the power source and the anode.

In steam plasma burners of the present type, an electric arc is ignited by the aid of a power source between a negatively poled cathode and a positively poled anode which is configured as a nozzle on the tip of the burner. The water or fluid is supplied to the burner from a tank via an appropriate duct, and there is heated to vapor by the aid of a heating means and conducted through appropriate channels into the combustion chamber, where it generates plasma, being a plasma-forming medium. The plasma jet emerges from the nozzle in a currentless manner and, due to its high energy density, is used for melting workpieces. In addition to cutting workpieces, a steam plasma burner can also be used to join workpieces.

The use of water or a fluid instead of a gas as a medium that may be turned into plasma offers the advantage that no gas bottles are required. Water is available in most places, or can be easily provided. To form a gas that can be turned into plasma, the water or fluid must, however, be evaporated.

After having switched on a steam cutting device, the heating element of the steam plasma burner, which evaporates the liquid medium, is switched on in order to reach the operating temperature. When the operating temperature has been reached, the steam plasma burner is in the “standby-mode” or idle mode. In order to bring the steam plasma burner into its operating state, a so-called pilot arc is ignited between the cathode and the anode. The liquid medium evaporated by the heating element forms the plasma gas which drives the electric arc outwards through the outlet opening of the anode which is designed as a nozzle. In this state, the burner is in the so-called “non-transmitting mode”. As the burner approaches the workpiece connected with the power source, a partial current starts flowing over the workpiece to the cathode to cause the formation of a working arc between the workpiece and the cathode upon exceeding of a defined current. As soon as the working arc has been formed between the cathode and the workpiece, the pilot arc is turned off by disconnecting the power source, and the current is increased to the desired cutting current so as to enable the start of the processing of the workpiece. This mode is referred to as the “transmitting mode”.

When the steam plasma burner is moved away from the workpiece, a break of the working arc and an interruption of the processing of the workpiece may be caused. In order to continue processing, the pilot arc must again be ignited and the burner must be brought into the non-transmitting mode and, finally, into the transmitting mode. The extinction of the electric arc constitutes a problem especially in steam plasma burners, since the continued supply of the plasma-forming medium may cause the burner to cool off and the operation to be interrupted. The control of switchovers between non-transmitting and transmitting modes is, therefore, of utmost importance particularly for steam plasma burners.

In the prior art, various methods for controlling the switchover from the non-transmitting mode into the transmitting mode as a function of measured currents or voltages have been known. U.S. Pat. No. 6,133,543 A, for instance, describes a device and method for controlling a plasma arc, with the current of the electric arc being detected in the transmitting mode and used for the control of the engagement of the power source. The burner used there is a conventional burner operated with gas.

WO 2004/022276 A1 too discloses a plasma burner in which various operating currents and voltages are monitored in order to optimize the switchover from the pilot arc to an operating arc.

It is the object of the present invention to provide an above-identified method for operating a steam plasma burner, which allows for the achievement of an optimum switchover of the respective operating states. The method according to the invention is to ensure a substantially interruption-free processing of workpieces and, hence, optimum processing results.

Another object of the present invention resides in providing an above-identified steam cutting device which enables the achievement of an optimum operation of the steam plasma burner.

The first object according to the invention is achieved by an above-identified method in which the voltage between the cathode and the workpiece is monitored during the working operation and the power source is reconnected to the anode to newly form the pilot arc as soon as the voltage exceeds a threshold value. The core of the method according to the invention resides in the rapid changeover from the transmitting mode into the non-transmitting mode when the steam plasma burner has been moved too far away from the workpiece and the extinction of the working arc is imminent. The removal of the steam plasma burner from the workpiece is determined by measuring the voltage between the cathode and the workpiece. Due to the fact that the anode of the steam plasma burner is reconnected to the power source when a preset threshold value is exceeded, and the pilot arc between the cathode and the anode is thus reignited, the burner will remain in the non-transmitting mode even upon extinction of the working arc. Cooling off of the burner by the supplied plasma-forming medium will thereby be prevented, and the immediate continuation of the operation will be ensured, as soon as the desired distance of the burner from the workpiece has again been reached. In that case, the engagement of the power source to the anode must be effected as rapidly as possible after the threshold value for the voltage between the cathode and the workpiece has been exceeded, in order to ensure that the pilot arc will be ignited before the working arc will be extinguished.

The threshold value is advantageously adjustable so as to enable different operating parameters and burner types to be taken into account.

In an advantageous manner, different threshold values are deposited in a memory, and retrievable and/or adjustable, as a function of the steam plasma burners used.

In order to be able to readjust the burner during the working operation, the operating current is advantageously adjustable during the working operation. The intensity of the operating current is adapted to the workpiece to be worked on.

According to a further characteristic feature of the invention, it is contemplated that the power source is switched off from the anode when the current between the workpiece and the cathode exceeds a threshold value. By monitoring the current between the workpiece and the cathode, the partial current between the cathode and the workpiece, which starts flowing as the burner approaches the workpiece, is monitored. As soon as the measured current exceeds a defined threshold value, the pilot arc is extinguished by switching off the power source from the anode such that only the working arc will continue to burn. This represents the switchover from the non-transmitting mode into the transmitting mode.

In doing so, it is advantageous if the power source is switched off from the anode after a pregiven time duration, as soon as the current exceeds said threshold value. The adjustment of said time duration ensures that the pilot arc will burn for a certain time before being extinguished again. Too high switching frequencies, which would stress the switch, and the formation of vibrations will thereby be prevented. The time duration may be effected by the start of a time function element at the time of the recognition of the exceeding of the threshold value.

The minimum time duration over which the pilot arc must burn before being extinguished again advantageously ranges between 1 and 1.4 ms.

The threshold value of the current between the workpiece and the cathode is preferably adjustable as well.

The pilot arc can be ignited by applying a high-frequency voltage between the cathode and the anode.

It is likewise possible that the pilot arc is ignited by lifting an axially displaceable cathode from the anode. With such a configuration, the cathode is located on the anode in the switched-off state of the steam plasma burner. In this state, a short-circuit, thus, prevails between the cathode and the anode. It is only in the operating state that the cathode is preferably automatically lifted from the anode by the supplied liquid medium of the steam plasma burner so as to allow the ignition of a pilot arc between the cathode and the anode.

In order to monitor the short-circuit between the anode and the cathode, the voltage between the cathode and the anode can be measured and compared with the voltage between the cathode and the workpiece, and the operating current can be reduced in case of agreement, during the working operation, as in correspondence with a further characteristic feature of the invention. It is thereby safeguarded that the operating current is reduced at an encounter of the cathode with the anode, which will save both the cathode and the anode.

It is further feasible to measure the voltage between the cathode and the anode and prevent the switching-off of the power source from the anode at the detection of a short-circuit. By this measure, the ignition of an electric arc between the burner and the workpiece will be prevented with the anode and the cathode being short-circuited. It is only after the ignition of a pilot arc between the nozzle and the cathode, which is not feasible before the opening of the short-circuit between the anode and the cathode, that the switching off of the pilot arc and, hence, the achievement of the transmitting mode will be enabled.

If the switching on and/or off of the power source from the anode according to a pregiven function is, for instance, realized in a step- or ramp-like manner, the components will be saved, since the switchover does not occur all of a sudden.

In an advantageous manner, the flow rate of the water or fluid of the steam plasma burner is adjustable. Thus, for instance, also the cooling of the burner can be improved by increasing the flow rate.

The object according to the invention is also achieved by an above-identified steam cutting device comprising a device for measuring the voltage between the cathode and the workpiece, which measuring device is connected with the control device. By detecting the voltage between the cathode and the workpiece, said voltage can be compared with a pregiven threshold value in the control device so as to subsequently control in a suitable manner the switch arranged in the connection between the power source and the anode.

Advantageously, a device for measuring the current between the cathode and a workpiece is also provided, which measuring device is connected with the control device. This allows the selective switchover from the non-transmitting mode into the transmitting mode when a defined threshold value for the current between the cathode and the workpiece is exceeded.

A device for measuring the current between the workpiece and the cathode is also of advantage, which measuring device is connected with the control device. This current measuring device serves to detect the operating current during operation.

In order to detect a short-circuit between the burner and the workpiece, a device for measuring the voltage between the cathode and the workpiece may also be provided, which measuring device is connected with the control device.

If the control device is comprised of an analog circuit, the short switchover times required or desired, in particular when changing from the transmitting mode to the non-transmitting mode, will be achieved. In a control device formed by a micro-controller, these can frequently not be achieved by a software solution.

The switch is preferably comprised of a transistor, in particular an IGBT (insulated gate bipolar transistor).

In an advantageous manner, a memory for depositing predefined threshold values is provided, which is connected with the control device.

The present invention will be explained in more detail by way of the annexed drawings. Therein:

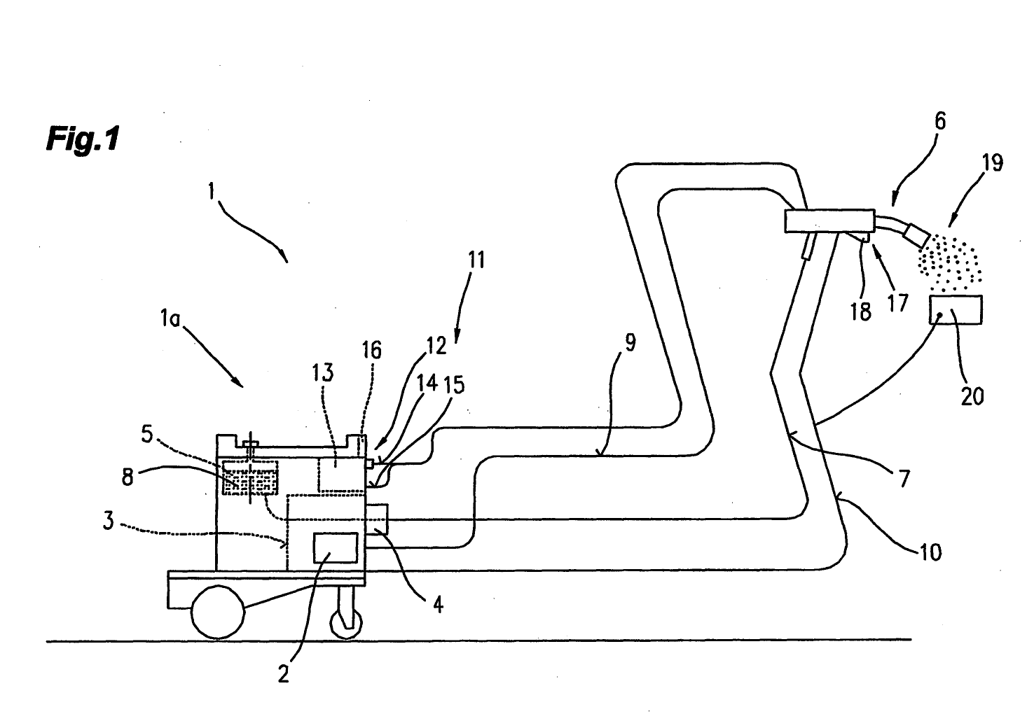

FIG. 1 is a schematic illustration of a steam cutting device;

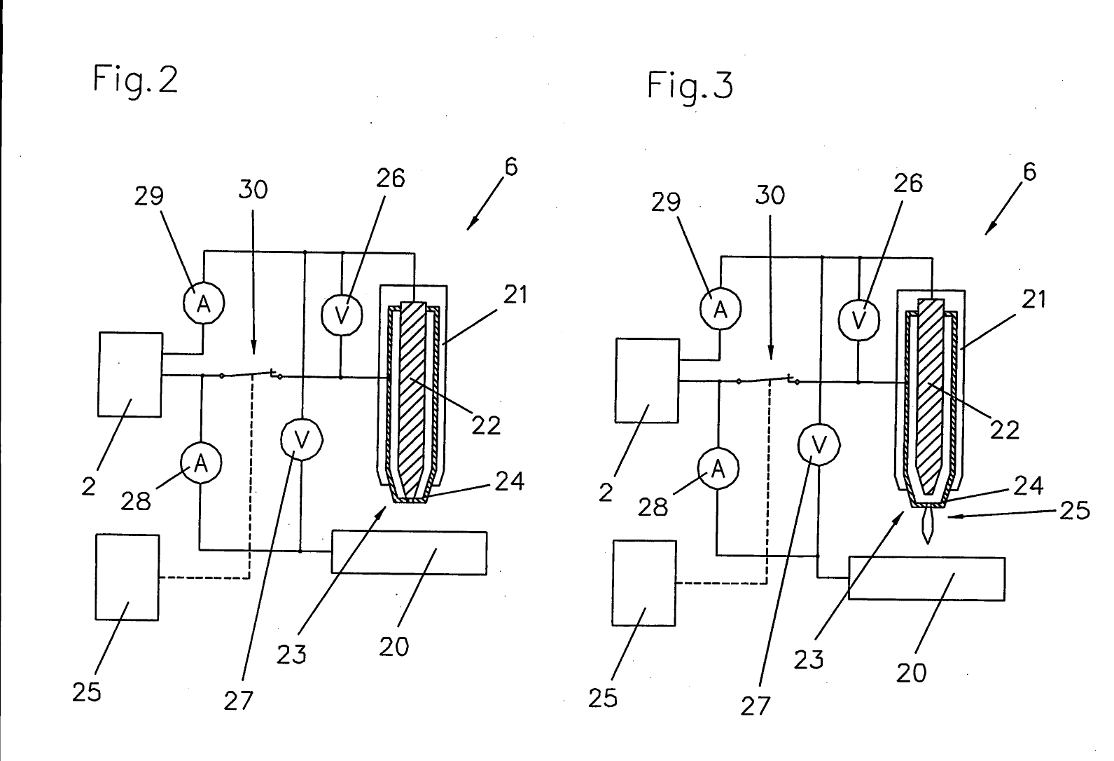

FIG. 2 is a schematic illustration of a steam plasma burner in the idle state;

FIG. 3 is a schematic illustration of a steam plasma burner in the non-transmitting mode; and

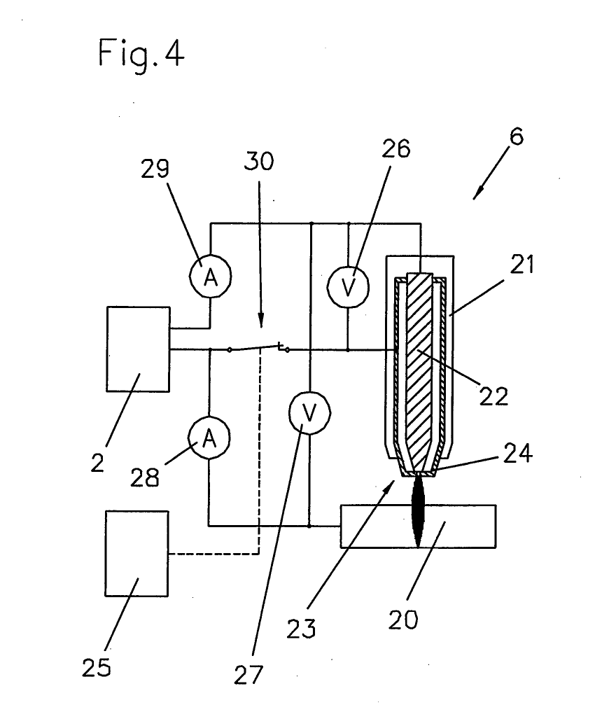

FIG. 4 is a schematic illustration of a steam plasma burner in the transmitting mode.

FIG. 1 depicts a steam cutting device 1 comprising a basic device 1a for a steam cutting procedure. The basic device 1a comprises a current source 2, a control device 3 and a blocking element 4 associated with the control device 3. The blocking element 4 is connected with a container 5 and a steam plasma burner 6 including a burner handle 6a and a burner body 6b, via a supply line 7 in a manner that the steam plasma burner 6 can be supplied with a fluid 8 provided in the container 5. The supply of the steam plasma burner 6 with electric energy takes place via lines 9, 10 from the current source 2.

To provide cooling of the steam plasma burner 6, the latter is connected with a fluid container 13 by a cooling circuit 11, optionally via an interposed flow monitor 12. When putting the burner 6, or basic device 1a, into operation, the cooling circuit 11 will be started by the control device 3 to provide cooling of the burner 6 via the cooling circuit 11. To form the cooling circuit 11, the burner 6 is connected with the fluid container 13 via cooling lines 14, 15.

Moreover, the basic device 1a may comprise an input and/or display device 16 to enable the adjustment and display of the different parameters or operating states of the steam cutting device 1. The parameters adjusted via the input and/or display device 16 are transmitted to the control device 3 to accordingly govern the individual components of the steam cutting device 1.

Furthermore, the steam plasma burner 6 may comprise at least one operating element 17, in particular a push-button switch 18, which enables the operator, by activating and/or deactivating the push-button switch 18, to inform the control device 3 from the burner 6 that a steam cutting procedure is to be started and performed. Moreover, the input and/or display device 16 may, for instance, serve to make preadjustments and, in particular, predefine the material to be cut, the employed fluid and, for instance, current and voltage characteristics. It goes without saying that further operating elements may be arranged on the burner 6 to adjust one or several operating parameters of the steam cutting device 1 from the burner 6. To this end, such operating elements can be connected to the basic device 1a, in particular control device 3, either directly via lines or via a bus system.

Upon actuation of the push-button switch 18, the control device 3 activates the individual components required for the steam cutting procedure. Thus, a pump (not illustrated), the blocking element 4 as well as the current source 2 are, for instance, activated first to start the supply of fluid 8 and electric energy to the burner 6. After this, the control device 3 activates the cooling circuit 11 to enable the cooling of the burner 6. By supplying fluid 8 and energy, in particular current and voltage, to the burner 6, the fluid 8 will be converted into a high-temperature gas 19, in particular plasma, in the burner 6 so as to enable the execution of a cutting process on the workpiece 20 by the gas 19 flowing out of the burner 6.

FIGS. 2 to 4 depict schematic illustrations of a steam plasma burner 6 according to the invention in different operating states. The steam plasma burner 6 comprises a housing 21, in which a cathode 22 is arranged, which is connected with the power source 2. The anode 24 in the form of a nozzle 23 is connected with the positive pole of the power source 2.

In the idle state or standby mode according to FIG. 2, the axially displaceable cathode 22 is pressed at the nozzle 23. In this mode, no electric arc can be ignited between the cathode 22 and the anode 24 because of an existing short-circuit. The heating means contained in the steam plasma burner 6 for evaporting the water can already be activated for preheating the working medium.

To ignite a pilot arc between the cathode 22 and the anode 24, the supply of liquid medium, in particular water, is activated as in accordance with FIG. 3, whereby the axially displaceable cathode 22 is lifted from the nozzle 23 and, with the appropriate power present, a pilot arc is ignited between the cathode 22 and the anode 24. Instead of such a contact ignition, the ignition of the pilot arc can also be effected by engaging a high-frequency voltage. The water evaporated in the heating means is supplied to the combustion chamber, where it serves as a medium forming a plasma jet. The plasma jet is pressed out through the opening 25 provided in the anode 24 which is designed as a nozzle 23 and, due to its high energy density, can be used for cutting and also connecting workpieces 20. The steam plasma burner 6 is in the so-called non-transmitting mode.

In order to optimize the switchover from the standby mode according to FIG. 2 into the non-transmitting mode according to FIG. 3, various operating parameters are measured and fed to a control device 25 which controls a switch 30 arranged between the power source 2 and the anode 24 of the steam plasma burner 6. Concretely, detections are made of the voltage U_{NUE} between the cathode 22 and the anode 24 by the aid of a voltage measuring unit 26, and of the current I_{UE} from the plus pole of the power source 2 to the workpiece 20 by the aid of a current measuring unit 28. Additional detections of the voltage U_{UE} between the cathode 22 and the workpiece 20 by the aid of a voltage measuring unit 27, and of the current I_{CUT} from the negative pole of the power source 2 to the cathode 22 of the steam plasma burner by the aid of a current measuring unit 29, may also be envisaged. The detected data are fed to the control device 25 controlling the switch for connecting the plus pole of the power source 2 with the anode 24. Via the voltage U_{NUE} between the cathode 22 and the anode 24 of the steam plasma burner, which is detected by the aid of the voltage measuring unit 26, it is recognized when the short-circuit between the cathode 22 and the anode or nozzle 24 has been broken. It is only then that the pilot arc between the cathode 22 and the anode 24 will be ignited.

As the steam plasma burner 6 approaches the workpiece 20 connected with the positive pole of the power source 2, a small partial current I_{UE} starts flowing over the transmitting current path. If the current I_{UE} to the workpiece 20, which is measured by the aid of the current measuring unit 28, exceeds a defined threshold value I_{UEs}, the switch 30 will be actuated by the control device 25, thus cutting the power source 2 off the anode 24. The electric arc is thereby forced to flash over from the cathode 22 to the workpiece 20 while the current supplied from the power source 2 can be raised to a defined cutting current I_{CUT}. In this case, the steam plasma burner 6 is in the so-called transmitting mode. As the steam plasma burner 6 is further removed from the workpiece 20, the voltage between the cathode 22 and the workpiece will increase, since the power source 2 aims to maintain the adjusted cutting current I_{CUT}. If the voltage U_{UE} detected by the voltage measuring unit 27 exceeds a defined threshold value U_{UEs}, the switch 30 is closed again, thus reconnecting the anode 24 with the positive pole of the power source 2 in order to prevent the electric arc from breaking. In this state, the steam plasma burner 6 has returned to the non-transmitting mode according to FIG. 3. Thus, switching is effected between the two operating states, i.e. the transmitting state and the non-transmitting mode, according to demand. In doing so, it is important that the control of the switch 30 be effected very rapidly. To this end, analogously configured control devices 25 are more suitable than realizations by micro-controllers. This automatic control of the electric arc is of great importance when cutting specific workpieces such as, e.g., perforated plates. In those cases, the electric arc would be extinguished by the constant change in the distance between the workpiece and the burner, which would call for a reignition of the pilot arc. Besides, the pulsation of the current may be of advantage to the cutting quality in some materials. By the method according to the invention, the energy input is reduced.

Another option is that the control device 3 acts upon the switching process. In this case, a switchover signal is generated, or must be cancelled, for instance at the first ignition of the pilot arc, i.e., at the activation of the process, whereby the control device 3 will release the switch 30 only upon exceeding a threshold value for the switchover signal, which means that a switchover from the non-transmitting mode into the transmitting mode will only be feasible if the switch-over signal has, for instance, exceeded 50V. This is to ensure that the short-circuit between the cathode and the anode will surely be broken, i.e. the cathode will be lifted from the anode, and the pilot arc between the cathode 22 and the anode 24 will surely burn in the interior of the burner 6.

Due to the release by the control device 3, the analogously configured control device 25 will then be able to open the switch 30 for the electric arc to be switched over to the workpiece 20. This will safeguard that no electric arc will burn between the nozzle 23 and the workpiece 20 unless the cathode 22 has been lifted off from the anode 24. If, for instance, the cathode 22 does, in fact, not lift off the anode 24, it will be impossible during operation to switch between the transmitting and the non-transmitting modes. It is, moreover, thereby ensured that a reliable heating of the burner 6 via the pilot arc will be achieved such that nothing but water vapor will emerge from the burner 6. This is prevented through the intervention by the control device 3, since that signal cannot be extinguished, or an appropriate signal cannot be generated, before an ignition has been effected between the nozzle 23 and the cathode 24, in order to enable the operation of the switch.

Another intervention by the control device 3 may comprise the monitoring by the control device 3, of the pilot arc in the transmitting mode, in which the electric arc is burning between the workpiece 20 and the cathode 22, when changing back into the non-transmitting mode, i.e. the pilot arc, which means that the pilot arc has to burn over a defined period of time, preferably 1.2 ms, between the nozzle 23 and the cathode 24, whereupon an interrogation will be made as to where the current is flowing, before the electric arc can again be switched onto the workpiece 20 and the pilot is being maintained, respectively. It is thereby ensured that no vibration, i.e. toggling, will occur since the employed switch 30 would not sustain high switching frequencies.

It is, of course, also possible to realize the circuit configuration digitally or analogously, whereby, with a digital configuration, the control means 25 may be integrated in the control device 3, or even realized by the latter.

1-21. (canceled)

22. A method for operating a steam plasma burner (6) including a cathode (22) and an anode (24) in the form of a nozzle (23) for processing a workpiece (20), wherein during operation a current is impressed between the cathode (22) and the anode (24) and/or the workpiece (20) by the aid of a power source (2), whereby, after the ignition of a pilot arc between the cathode (22) and the anode (24), a working arc is formed between the cathode (22) and the workpiece (20) by the steam plasma burner (6) approaching the workpiece (20), and the pilot arc is extinguished by the power source (2) being switched off from the anode (24), and the current is increased to a predetermined operating current, and wherein the voltage (U_{UE}) between the cathode (22) and the workpiece (20) is monitored during the working operation and the power source (2) is reconnected to the anode (24) to newly form the pilot arc when the voltage (U_{UE}) exceeds a threshold value (U_{UEs}), wherein the power source (2) is switched off from the anode (24) when the current (I_{UE}) between the workpiece (20) and the cathode (2) exceeds a threshold value (I_{UEs}).

23. A method according to claim 22, wherein the threshold value (U_{UEs}) is adjustable.

24. A method according to claim 22, wherein different threshold values (U_{UEs}) are deposited, and adjustable, as a function of the steam plasma burner (6) used.

25. A method according to claim 22, wherein the operating current (I_{CUT}) is adjustable during the working operation.

26. A method according to claim 22, wherein the power source (2) is switched off from the anode (24) after a pregiven time duration (Δt), as soon as the current (I_{UE}) exceeds the threshold value (I_{UEs}).

27. A method according to claim 26, wherein said time duration (Δt) is 1 to 1.4 ms.

28. A method according to claim 22, wherein the threshold value (I_{UEs}) of the current is adjustable.

29. A method according to claim 22, wherein the pilot arc is ignited by applying a high-frequency voltage between the cathode (22) and the anode (24).

30. A method according to claim 22, wherein the pilot arc is ignited by lifting an axially displaceable cathode (22) from the anode (24).

31. A method according to claim 30, wherein during the working operation, the voltage (U_{NUE}) between the cathode (22) and the anode (24) is measured and compared with the voltage (U_{NUE}) between the cathode (22) and the workpiece (20), and the operating current is reduced in case of agreement.

32. A method according to claim 30, wherein the voltage (U_{NUE}) between the cathode (22) and the anode (24) is measured and the switching-off of the power source (2) from the anode (24) is prevented at the detection of a short-circuit.

33. A method according to claim 22, wherein the switching on and/or off of the power source (2) from the anode (24) is realized according to a pregiven function and, for instance, in a step- or ramp-like manner.

34. A method according to claim 22, wherein the flow rate of the water of the steam plasma burner (6) is adjusted.

35. A steam cutting device (1) including a steam plasma burner (6) including a cathode (22) and an anode (24) in the form of a nozzle (23), a power source (2) connected with the cathode (22), on the one hand, and the workpiece (20) to be processed as well as the anode (24), on the other hand, a control device (25) for controlling a switch (30) arranged in the connection between the power source (2) and the anode (24), and a device (27) for measuring the voltage (U_{UE}) between the cathode (22) and the workpiece (20), wherein a device (28) for measuring the current (I_{UE}) between the cathode (22) and the workpiece (20) is provided, and wherein the measuring devices (27, 28) are connected with the control device (25).

36. A steam cutting device (1) according to claim 35, wherein a device (29) for measuring the current (I_{CUT}) between the cathode (22) and the workpiece (20) is provided, which measuring device (29) is connected with the control device (25).

37. A steam cutting device (1) according to claim 35, wherein a device (26) for measuring the voltage between the cathode (22) and the anode (24) is provided, which measuring device (26) is connected with the control device (25).

38. A steam cutting device (1) according to claim 35, wherein the control device (25) is comprised of an analog circuit.

39. A steam cutting device (1) according to claim 35, wherein the switch (30) is comprised of a transistor, in particular an IGBT (insulated gate bipolar transistor).

40. A steam cutting device (1) according to claim 35, wherein a memory for depositing predefined threshold values is provided, which memory is connected with the control device (25).
